(19) United States
(12) Patent Application Publication
(10) Pub. No.: US 2026/0076512 A1
(43) Pub. Date: Mar. 19, 2026

(54) DEVICE FOR SLICING AND RECONSTITUTING FOODSTUFFS, AND ACCESSORY FOR PRODUCING SUCH A DEVICE

(71) Applicant: HAMEUR, Luxembourg (LU)

(72) Inventors: Loick FEVRE, Luxembourg (LU); Pierre DUMAS, Luxembourg (LU)

(21) Appl. No.: 19/102,398

(22) PCT Filed: Aug. 31, 2023
(86) PCT No.: PCT/EP2023/073916

§ 371 Date: Feb. 9, 2025

(30) Foreign Application Priority Data
Aug. 31, 2022 (FR) FR2208726
Nov. 8, 2022 (FR) FR2211636

(51) Int. Cl. A47J 43/07; A47J 43/046

(52) U.S. Cl. CPC A47J 43/0716; A47J 43/046

(57) ABSTRACT

The invention relates to a device (20) for processing foodstuffs comprising:
a motor unit (21) connected to a drive shaft (22) for driving a disc (35) comprising a cutting element having a radial cutting amplitude,
a chute (27) for inserting the foodstuffs to be cut,
a device (25) for channelling the cut foodstuffs out of the device having at least one side holding surface (42) and a sliding surface (33).

The channelling device successively comprises, at the outlet of the sliding surface leading to the outside of the device, a receptacle (26) for the sliced foodstuffs, the horizontal cross section of which has a larger dimension that is equal to between three quarters and one and a half times the radial cutting amplitude, and an abutment surface for stopping the movement of the cut foodstuffs.

### TECHNICAL FIELD OF THE INVENTION

The present invention relates to a device for slicing and reconstituting foodstuffs, and an accessory for producing such a device. It applies, in particular, to the field of appliances for domestic, restaurant or collective kitchens.

### STATE OF THE ART

The currently known devices for slicing foodstuffs, in particular fruits and/or vegetables, produce slices that are arranged randomly in a recipient, for example a bowl or a container. The slices are therefore arranged in a haphazard way. The reconstruction of sliced foodstuffs for aesthetic or culinary reasons is consequently time-consuming and expensive. In addition, for operators that have to mass-produce dishes, e.g. hamburgers, the haphazard arrangement of the slices means that additional movements are necessary, compared to the case in which the slices are in order, e.g. superposed.

### PRESENTATION OF THE INVENTION

The present invention aims to remedy all or part of these drawbacks. To this end, according to a first aspect, the present invention envisages a device for processing foodstuffs according to claim 1. Thanks to these provisions, the successive slices of cut foodstuffs are held and channelled out of the device and reach the outlet of the device, substantially in the same location defined by the outlet of the channelling device. The slices of cut foodstuffs are stopped by the abutment surface and then drop vertically under the effect of gravity, which improves the reconstitution of the cut foodstuffs. Because of the dimension of the horizontal cross-section of the receptacle, the successive slices are superposed in it in the same order as they were cut, and the cut foodstuffs are reconstituted, i.e. take substantially its original shape, in this receptacle.

In some embodiments, the channelling device has a transversal dimension of the outlet for cut foodstuffs from the sliding surface that is equal to between three quarters and one and a half times the radial cutting amplitude. The sliced foodstuffs are therefore guided directly to the receptacle at the outlet of the sliding surface.

In some embodiments, the sliding surface of the channelling device comprises a portion inclined relative to the vertical.

In some embodiments, the portion of the sliding surface inclined relative to the vertical forms an angle of between 20 degrees and 70 degrees to the vertical.

The sliced foodstuffs are therefore pushed towards the receptacle not only by the disc for processing foodstuffs, but also by gravity.

In some embodiments, a portion of the sliding surface at the lowest end of the portion inclined relative to the vertical, is horizontal. This horizontal sliding surface moves the slice of cut foodstuffs into a horizontal position, which fosters good reconstitution of the cut foodstuffs.

In some embodiments, the motor unit comprises a ramp inclined relative to the vertical, enclosed by vertical rims, this inclined ramp having, relative to the vertical, a slope with an inclination substantially equal to the slope of an inclined portion of the sliding surface of the channelling device. When the channelling device is nested in the motor unit, the portion of this device comprising the inclined portion is positioned in the empty volume formed between the inclined ramp and the vertical rims. The similar slopes of the ramp and the inclined portion of the channelling device foster a continuous physical contact between the motor unit and the channelling device.

In some embodiments, at least one portion of the sliding surface is horizontal. This horizontal sliding surface moves the slice of cut foodstuffs into a horizontal position, which fosters good reconstitution of the cut foodstuffs.

In some embodiments, the sliding surface bears irregularities configured to separate the cut foodstuff from the rest of this sliding surface.

Thanks to these provisions, a moist slice of foodstuff, e.g. a slice of fruit, is prevented from adhering by capillarity to the surface of this inclined surface is prevented.

In some embodiments, the irregularities take the form of protrusions in parallel line segments. These protrusions make it easier for the slice of cut foodstuff to slide and also for this slice to keep moving on this inclined portion.

In some embodiments, the channelling device has a transversal dimension between three-quarters and one and a half times the radial cutting amplitude, from an upper platform positioned below the chute for the reception of foodstuffs and substantially perpendicular to the axis of the rotating shaft, to the outlet for cut foodstuffs leading to the outside of the device. The slices of cut foodstuffs are therefore channelled throughout their trajectory to the receptacle.

In some embodiments, the upper platform only partially surrounds the rotating drive shaft. This characteristic makes it easier to position and remove the channelling device.

In some embodiments, the receptacle comprises a side opening with a width, measured in a horizontal cross-section, of between two and four centimetres.

Thanks to these provisions, the user can recover reconstituted foodstuffs by placing a first finger under this foodstuff and a second finger above this foodstuff, grasping the reconstituted foodstuff between these fingers, and raising the first finger along the side opening of the receptacle.

In some embodiments, the receptacle has a tapered cylindrical portion extending into a concave bottom. This shape matches the most common shape of foodstuffs to be reconstituted after cutting into slices. It therefore improves the reconstitution of foodstuffs.

In some embodiments, the circle inscribed in a horizontal inner cross-section of the receptacle has a diameter between three quarters and one and a half times the radial cutting amplitude. This dimension improves the reconstitution of foodstuffs.

In some embodiments, a side surface for holding cut foodstuffs on the channelling device comprises an upper prolongation forming a support for a cover comprising the chute. The channelling device is therefore held in position by the cover.

In some embodiments, the channelling device comprises two side edges. The slices of cut foodstuffs are therefore channelled better.

In some embodiments, the receptacle can be removed from the device or the channelling device. The receptacle can therefore be interchanged according to the dimensions of the foodstuffs to be cut.

In some embodiments, the abutment surface for stopping the movement of the cut foodstuffs extends beyond the plane of the outer edge of the sliding surface. In this way, even if a slice of cut foodstuff arrives quickly, it is stopped by this abutment and is not likely to go beyond this.

In some embodiments, the channelling device can be removed from the motor unit manually and without tools. The device can therefore be utilised for a variety of uses, with or without the channelling device. In addition, the latter can be easily cleaned after being removed from the device.

According to a second aspect, the present invention envisions a removable accessory for the device that is the subject of the invention, which comprises the device for channelling the cut foodstuffs.

As the features, advantages and aims of this accessory are similar to those of the device that is the subject of the invention, they are not repeated here.

### BRIEF DESCRIPTION OF THE FIGURES

Other advantages, aims and features of the present invention will become apparent from the description that will follow, made, as a non-limiting example, with reference to the drawings included in an appendix, in which:

FIG. 1 represents, in perspective, an exploded view of a first particular embodiment of the device that is the subject of the invention;

FIG. 2 represents, in perspective, the different elements of the device shown in FIG. 1, partially assembled;

FIG. 3 represents, in a vertical cross-section, the device shown in FIGS. 1 and 2, once assembled;

FIG. 4 represents, in perspective, a particular embodiment of an accessory that is the subject of the invention;

FIG. 5 represents, in perspective, a detail of realisation of the accessory shown in FIG. 4;

FIG. 6 represents, in perspective, an exploded view of the device shown in FIG. 1;

FIG. 7 represents, in perspective, a food processing disc of the device shown in FIGS. 1 to 6;

FIG. 8 represents, schematically and in partial perspective, a second embodiment of the device that is the subject of the invention; and

FIG. 9 represents, in a vertical cross-section, a third particular embodiment of a device that is the subject of the invention, once assembled.

### DESCRIPTION OF THE EMBODIMENTS

The present description is given in a non-limiting way, in which each characteristic of an embodiment can be combined with any other characteristic of any other embodiment in an advantageous way.

The indefinite articles “one” or “a”, as used in the description and in the claims, must be understood as meaning “at least one”, except when the contrary is clearly indicated. The expression “and/or”, as it is used in the present document and in the claims, must be understood as meaning “one or other, or both” of the elements thus connected, i.e. elements that are present conjunctively in some cases and disjunctively in other cases. The multiple elements listed with “and/or” must be interpreted in the same way, i.e. “one or more” of the elements thus connected. Other elements can possibly be present, other than the elements specifically identified by the clause “and/or”, whether or not they are linked to these specifically identified elements. Therefore, as a non-limiting example, a reference to “A and/or B”, when it is used in conjunction with open-ended language such as “comprising”, can refer, in one embodiment, to A only (possibly including elements other than B); in another embodiment, to B only (possibly including elements other than A); in yet another embodiment, to A and B (possibly including other elements); etc.

As used here in the description and in the claims, “or” must be understood as having the same meaning as “and/or” as defined above. For example, when separating elements in a list, “or” or “and/or” must be interpreted as being inclusive, i.e. the inclusion of at least one, but also of more than one, of a number or a list of elements, and, optionally, of additional elements not listed. Only the terms clearly indicating the contrary, such as “only one of” or “exactly one of”, or, when they are used in the claims, “consisting of”, refer to the inclusion of a single element of a number or a list of elements. In general, the term “or” as it is used here must only be interpreted as indicating exclusive alternatives (i.e. “one or the other, but not both”) when it is preceded by exclusivity terms, such as “either”, “one of”, “only one of”, or “exactly one of”.

As used here in the present description and in the claims, the expression “at least one”, in reference to a list of one or more elements, must be understood as meaning at least one element chosen from among one or more elements in the list of elements, but not necessarily including at least one of each element specifically listed in the list of elements and not excluding any combination of elements in the list of elements. This definition also allows the optional presence of elements other than the elements specifically identified in the list of elements to which the expression “at least one” refers, whether or not they are linked to these specifically identified elements. Therefore, as a non-limiting example, “at least one of A and B” (or, equivalently, “at least one of A or B” or, equivalently, “at least one of A and/or B”), can refer, in one embodiment, to at least one, possibly including more than one, A, with no B present (and possibly including elements other than B); in another embodiment, to at least one, possibly including more than one, B, with no A present (and possibly including elements other than A); in yet another embodiment, to at least one, possibly including more than one, A and at least one, possibly including more than one, B (and possibly including other elements); etc.

In the claims, and also in the description below, all the transitive expressions such as “comprising”, “including”, “bearing”, “having”, “containing”, “involving”, “made of”, “formed of” and others, must be understood as being open, i.e. meaning including, but not limited to. Only the transitive expressions “consisting of” and “consisting essentially of” must be understood as closed or semi-closed expressions, respectively.

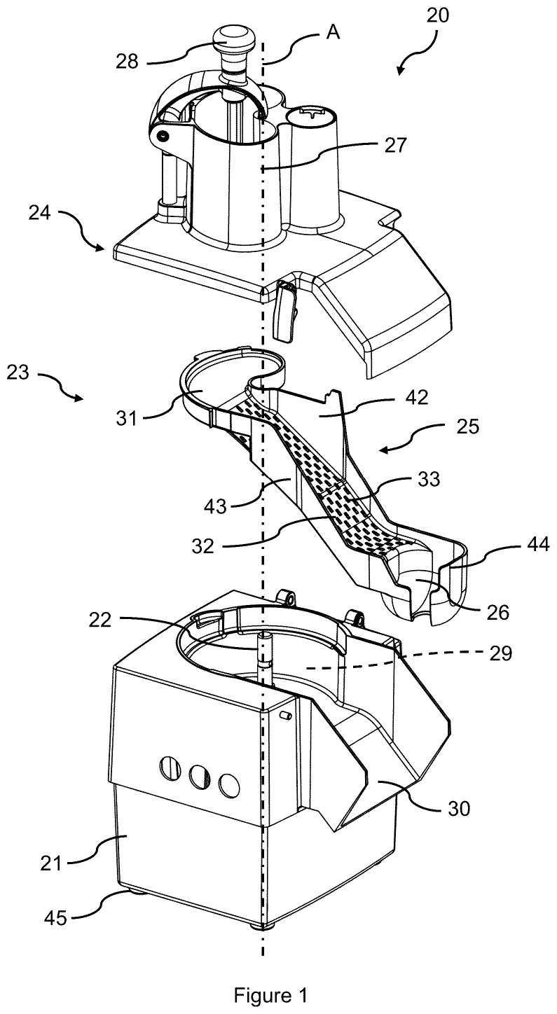

Throughout the description, the term “upper” refers to being located at the top in FIGS. 1 to 6, which correspond to the normal configurations of the mounting and use of the device and/or of the accessory comprising the channelling device, and “bottom” to being located at the bottom in FIGS. 1 to 6. The notions of vertical and horizontal flow from these definitions.

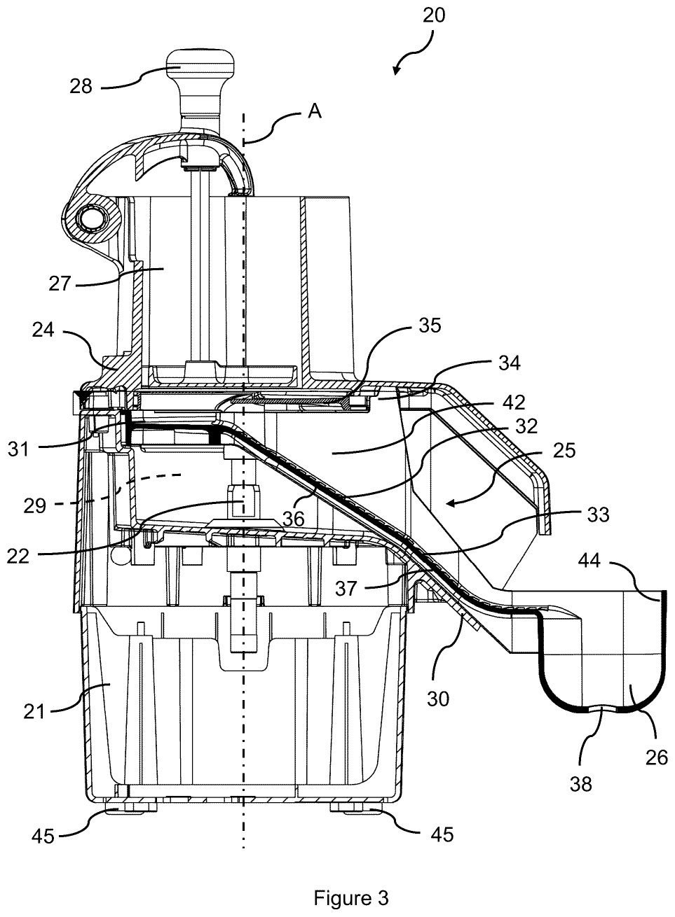

The vertical axis A is defined by gravity. Except for devices dedicated to being placed on inclined planes, this axis A is perpendicular to a plane defined by bearing points 45 (see FIG. 3) of the device when it is in a configuration of normal operation on a horizontal support. For devices dedicated to being placed on inclined planes, this vertical axis is adjusted by the inclination of this plane, relative to the horizontal.

In the specific case of each of the devices shown in FIGS. 1 to 9, the axis of rotation of the motor of the device and of the processing disc is vertical. The vertical axis A shown in FIGS. 1 to 4 and 6 to 9 is coincident with the axis of rotation of a drive shaft of a processing disc, and also corresponds to the axis of the shaft of a motor unit. Of course, in other embodiments (not shown), the axis of rotation of the motor and/or the axis of rotation of the processing disc are inclined relative to the vertical axis A.

Throughout the description, a first dimension “substantially equal” to a second dimension means that the first dimension is between three-quarters and one and a half times the second dimension. Preferably, the first dimension is therefore between one and one and a quarter times the second dimension.

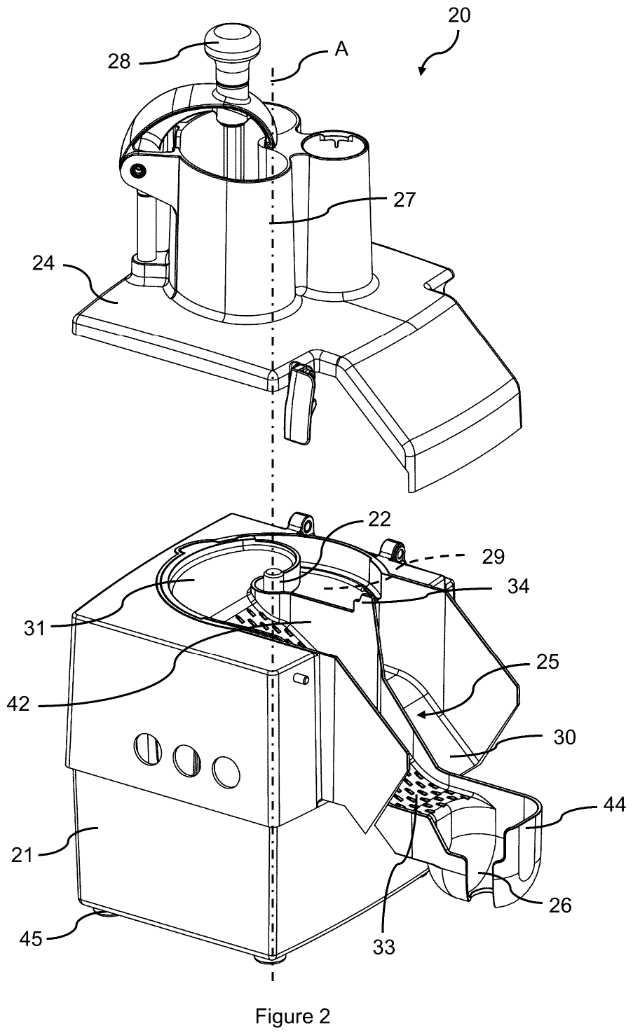

It is now noted that FIGS. 1 to 7 are to scale, even if the various figures may be to different scales. In FIGS. 1 and 2, the processing disc comprising the cutting blade is not shown, for reasons of clarity.

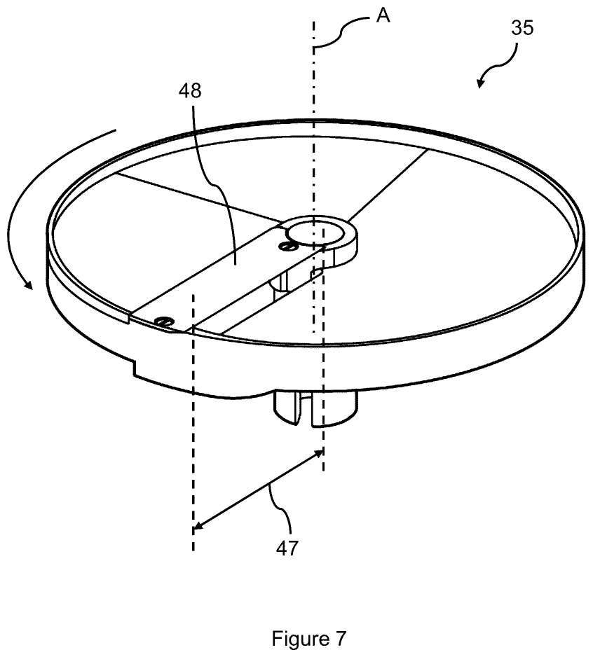

FIG. 1 shows, in a device 20 for processing the foodstuffs that is the subject of the invention. This device 20 comprises:
a motor unit 21 comprising a motor (not shown) connected to a rotating drive shaft 22;
a food processing disc 35 (see FIG. 7), comprising at least one blade 48 for cutting foodstuffs set in rotation by this shaft 22 and having a radial cutting amplitude 47; and
a cover 24 comprising a chute 27 for inserting the foodstuffs to be cut.

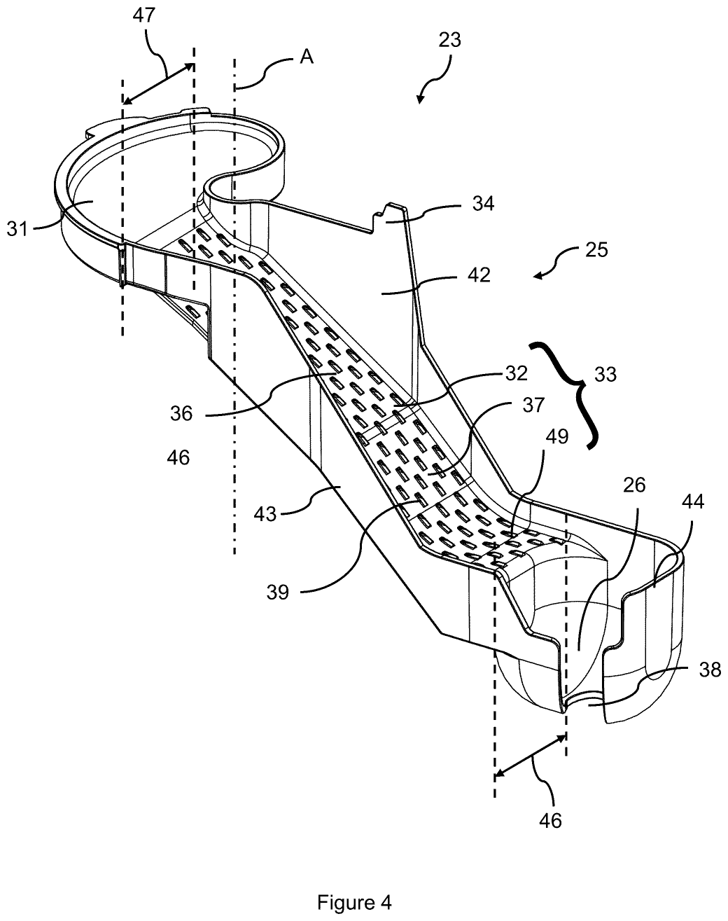

The device 20 also comprises a device 25 for channelling, during the operation of the device, cut foodstuffs out of the device. This device 25 has a side surface 42 for holding cut foodstuffs on this device 25. This device 25 also has a portion 32 inclined relative to the vertical A and, at least at the outlet leading to the outside of the device 20, a transversal dimension 46 (see FIG. 4) substantially equal to the radial cutting amplitude 47 (see FIG. 7), i.e. the difference between the radii, measured from the axis of the disc 35, of the two useable edges of the blade 48. The term “substantially equal” here means between 75 and 150% of the radial cutting amplitude and, preferably, between 100 and 125% of this radial amplitude. For example, two values are considered to be substantially equal when the difference between these two values is less than 15%, preferably less than 10%.

Note that the gravity relationships determine the arrangement of the processing disc (for example, a tool for cutting foodstuffs) 35 relative to the arrangement of the channelling device 25, such that the slices of cut foodstuffs successively reach the outlet of the device 20.

The inclined portion 32 of the channelling device 25 is equivalent to a sliding surface on which the slices of cut foodstuffs slide out of the device 20. In this way, the inclined portion 32 of the channelling device 25 plays a role in the descent of the slices of cut foodstuffs towards the outside of the device 20. Preferably, and as shown in FIGS. 1 to 7, the channelling device 25 comprises, on output, an abutment surface 44 for stopping the movement of the cut foodstuffs. The abutment surface 44 for stopping the movement of the cut foodstuffs is located on the other side of the receptacle 26 relative to the sliding surface 33, such that the slices of cut foodstuffs are stopped by this abutment and end course surface and then drop vertically under the effect of gravity into the receptacle 26.

Preferably, and as shown in FIGS. 1 to 7, the channelling device 25 has a transversal dimension substantially equal to the radial cutting amplitude 47, from an upper platform 31 positioned below the chute 27 of the cover 24 for the reception of cut foodstuffs and substantially perpendicular to the axis of the rotating shaft 22, to the outlet for cut foodstuffs leading to the outside of the device 20. The device 25 thus comprises a channel with a substantially constant width, which comprises its inclined portion 32. In other embodiments (not shown), the channelling device does not comprise such a channel. The passage of the motor shaft 22 from the motor unit 21 to the processing disc 35 is completely outside the channelling device 25. In this way, the channelling device 25 has no through-opening for the passage of the shaft 22, which facilitates the mounting and dismounting of the channelling device 25 in the device 20. Preferably, and as in the first embodiment of the device, the upper platform 31 only partially surrounds the rotating drive shaft 22. It is therefore kidney-shaped, which makes it easier to insert and remove the channelling device 25 into/from the device 20.

In the particular embodiment shown in FIGS. 1 to 7, the portion 32 inclined relative to the vertical A of the channelling device 25 forms an angle of between 20 degrees and 70 degrees to the vertical A, preferably between 30 degrees and 60 degrees.

In the particular embodiment shown in FIGS. 1 to 7, the portion 32 inclined relative to the vertical A of the channelling device 25 has, at its lowest end, a substantially horizontal lower sliding surface 49. Preferably, and as shown in FIGS. 1 to 7, the abutment surface 44 for stopping the movement of the cut foodstuffs is vertical, located opposite the sliding surface 33, on the other side of the receptacle 26 which it forms one wall of, and extends beyond the plane of the outer edge of the sliding surface 33, and in particular of its horizontal lower portion 49. In other embodiments (not shown), the inclined portion does not comprise such a horizontal outlet surface.

In the particular embodiment shown in FIGS. 1 to 7, the portion 32 inclined relative to the vertical A of the channelling device 25 bears irregularities 39 configured to separate the cut foodstuff from the rest of this portion inclined relative to the vertical A. In other embodiments (not shown), the inclined portion does not comprise irregularities.

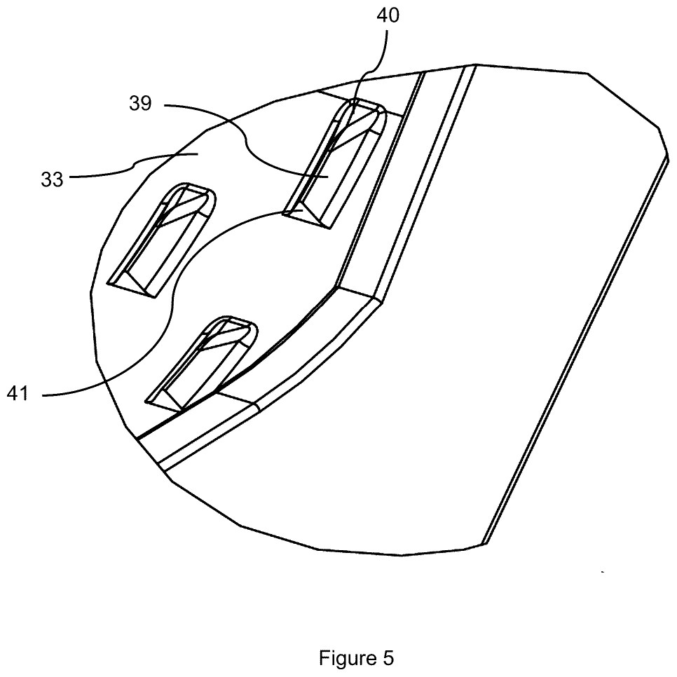

In the particular embodiment shown in FIGS. 1 to 7, these irregularities 39 take the form of protrusions (see FIG. 5) in line segments that are parallel to the maximum slope line of the inclined portion 32 and in a staggered arrangement. In other embodiments (not shown), the irregularities take the form of studs with a tapered spherical, ellipsoid or any other shape performing the function of separating the foodstuff from the rest of the surface of the inclined portion.

In the particular embodiment shown in FIGS. 1 to 7, the device 20 comprises, at the outer end of the device 25 for channelling the cut foodstuffs, a receptacle 26 for sliced foodstuffs, integral or not with the channelling device 25, the horizontal cross-section of which has a larger dimension substantially equal to the radial cutting amplitude 47. In other embodiments, the receptacle is separate from the device and the channelling device.

In the particular embodiment shown in FIGS. 1 to 7, the receptacle 26 comprises a lower side opening 38 with a width, measured in a horizontal cross-section, of between two and four centimetres.

In the particular embodiment shown in FIGS. 1 to 7, the receptacle 26 has a tapered cylindrical portion. In the particular embodiment shown in FIGS. 1 to 7, this tapered cylindrical portion extends into a concave bottom. In other embodiments, the receptacle 26 does not comprise a bottom. These embodiments are, for example, suitable for the reception of reconstituted cut foodstuffs on a bagging carousel.

Preferably, the circle inscribed in a horizontal inner cross-section of the receptacle 26 has a diameter substantially equal to the radial cutting amplitude 47. This inscribed circle is located, for example, half-way up the receptacle 26.

The present invention also envisions a removable accessory 23 for a device 20 that is the subject of the invention, an accessory 23 shown in its entirety in FIG. 4, which accessory comprises the channelling device 25 described above.

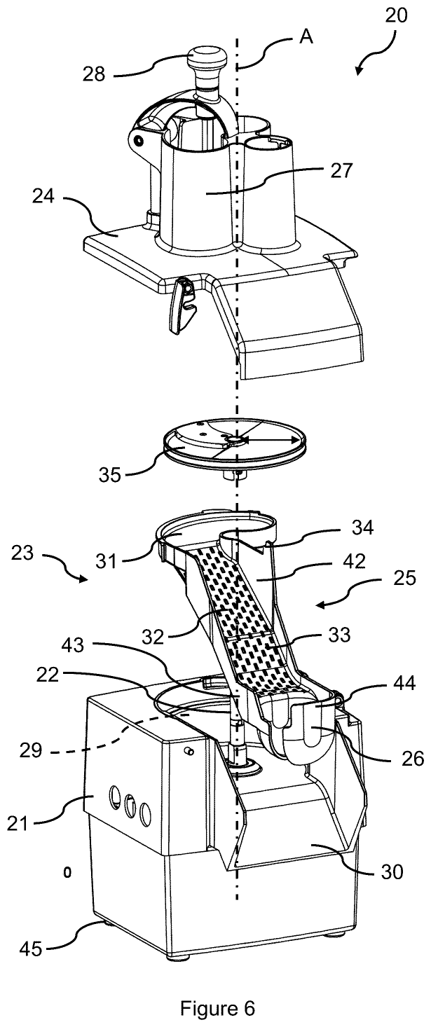

In some embodiments, such as that shown in FIGS. 1 to 7, the motor unit 21 comprises a central hollow part 29 (see, in particular, FIGS. 1 and 6) where a container for preparing foodstuffs is generally placed, in the absence of the channelling device 25. When this device 25 is mounted in the device 20, this central hollow part 29 holds an upper portion and an intermediate portion of the device 25 but not the receptacle 26. In particular, the central hollow part 29 forms an empty volume supplementary to the volume formed by the upper and intermediate portions of the device 25. When the device 20 is mounted, the upper portion and intermediate portion of the device 25 are completely or partially introduced into the central hollow part 29. In this way, these portions are therefore nested in the motor unit 21, as shown in FIG. 2. In particular, the device 25 is immobilised inside the central hollow part 29 when the device 20 is fitted with this device 25.

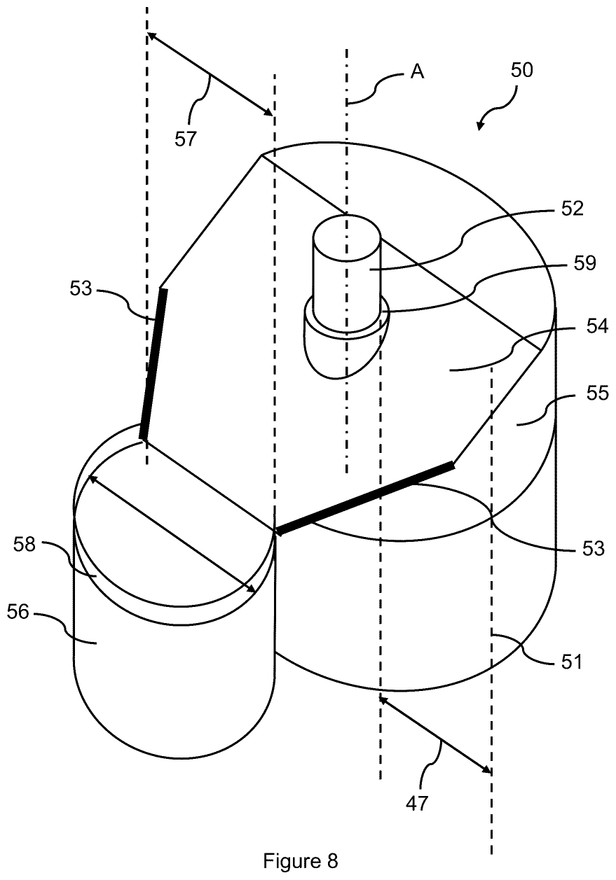

In some embodiments, such as that shown in FIG. 2, the rotating shaft 22 connected to the motor of the motor unit 21 is partially enclosed by the upper portion of the channelling device 25. In other words, in these embodiments, the channelling device 25 has no through-opening for the passage of the shaft 22. In some embodiments (see FIG. 8), the shaft 22 is completely enclosed by the upper portion of the channelling device 25, i.e. the device 25 has a through-opening for the passage of the shaft 22.

In some embodiments, such as that shown in FIGS. 1 to 3 and 6, the motor unit 21 also comprises an inclined ramp 30 enclosed by vertical rims. Note that the assembly formed by the inclined ramp 30 and the vertical rims forms an empty volume, i.e. with no material, linked to the central hollow part 29 of the motor unit 21. In particular, when the channelling device 25 is nested in the motor unit 21, the portion of the device 25 comprising the inclined portion 32 is positioned in the empty volume. Preferably, the inclined ramp 30 has a slope with an inclination substantially similar to the slope of the inclined portion 32 of the channelling device, so as to foster a continuous physical contact between the motor unit 21 and the channelling device 25. In this way, such an inclined ramp 30 of the motor unit 21 plays a role in supporting the channelling device 25.

In some embodiments, such as that shown in FIGS. 1 to 7, the channelling device 25 comprises a side holding surface 42 that is flat (see FIGS. 2 to 4 and 6), parallel to the vertical axis A. The side holding surface 42 is located on the side of the inclined portion 32 closest to the axis of the shaft 22. By means of an upper prolongation 34, the side holding surface 42 forms a support for a cover 24, as can be seen in FIG. 3. In other words, this upper prolongation 34 of the side surface 42 plays a role in keeping the device 25 in position under the cover 24, when the device 20 is mounted. Preferably, the channelling device also comprises a side holding surface 43 on the other side of the inclined portion 32, to form channel for circulating sliced foodstuffs.

In some embodiments, such as that shown in FIGS. 1 to 7, the cover 24 comprises a chute 27 for inserting the foodstuffs to be cut. Such an insertion chute 27 guides the foodstuffs to be cut towards the lower portion of the cover 24 and in particular towards the processing disc 35.

Preferably, the cover 24 is topped by a compression tamper 28. Such a tamper 28 comprises a handle for gripping by the user at the upper end, and a surface for compressing foodstuffs to be cut at the lower end. Note that the tamper 28 is mobile in translation relative to the upper portion of the cover 24 and along a direction, for example parallel to the axis A or to the axis of the shaft 22.

FIGS. 3, 6 and 7 show the processing disc 35 comprising the cutting blade 48 for the foodstuffs to be cut. Such a blade 48 cuts the foodstuffs into slices. The thickness of the slices can vary according to the needs, the cut foodstuffs and the requirements of the user, for example. Note that the insertion chute 27 maintains the orientation of the foodstuff with regard to the processing disc 35 during the use of the device 20. In addition, such a maintenance of the orientation is optionally reinforced by the compression tamper 28. In some variants, the processing disc 35 comprises several cutting blades ensuring the sequential and successive cutting of a foodstuff to be cut.

In some embodiments, such as that shown in FIGS. 1 to 7, the channelling device 25 comprises an upper platform 31. FIG. 3 shows the upper platform 31 positioned under the chute 27 of the cover 24 and under a portion of the processing disc 35, when the device 20 is mounted. Preferably, the upper platform 31 is substantially perpendicular to the axis of the shaft 22. The upper platform 31 plays a role in maintaining the orientation of the cut slice, with no significant inversion or rotation, before the slice reaches the inclined portion 32 of the channelling device 25.

In some embodiments (see FIG. 8), the channelling device 25 does not comprise an upper platform. In these variants, the cut slice drops directly onto the inclined portion of the channelling device.

In these embodiments, during the cutting of a foodstuff, the blade 48 slices the foodstuff. The slice obtained drops onto the upper platform 31. This slice is then drawn by the lower surface of the processing disc 35 towards to the inclined portion 32 of the channelling device 25. This movement is produced by suction effect, i.e. by a moist surface of the foodstuff, especially a fruit or vegetable, adhering on the lower surface of the processing disc 35, and/or by an abutment formed in the processing disc 35 below this lower surface.

In some embodiments (not shown), the longitudinal profile of the inclined portion 32 forms a curve that is differentiable at all points. In other words, such a profile has no angular point. In some embodiments, such as that shown in FIGS. 1 to 7, the longitudinal profile of the inclined portion 32 has at least one angular point. In other words, the inclined portion 32 is in two portions, 36 and 37, joined together at the location of the angular point. Note that these two portions correspond to an upper sliding portion 36 and an intermediate sliding portion 37 of the sliding portion 33. In particular, the angle of inclination of the upper inclined portion 36 relative to the vertical axis A is greater than the angle of inclination of the intermediate inclined portion 37.

For example, the presence of several slopes with different angles of inclination provides the channelling device 25 with adaptability according to the geometric and mechanical constraints of the device 20, and especially the constraints imposed by the dimensions of the motor unit 21 and the inclination of the inclined ramp 30.

In some preferred embodiments, such as that shown in FIGS. 4 and 5, the inclined portion 32 bears irregularities 39 forming protrusions in parallel line segments on the inclined portion 32. The protrusions 39 keep the slice away from the smooth surface of the inclined portion 32 and limit, for example, the friction and capillary forces against this smooth portion.

Preferably, as shown in FIG. 5, the irregularities 39 are prism-shaped. In particular, the prisms 39 have an upstream surface 40 forming a bevel and a downstream surface 41 forming a straight cross-section. Note that the surfaces 40 and 41 are adjacent to the smooth portion of the inclined portion 32 and are connected to one another by an edge of the prism 39.

In some embodiments, the surface 40 of the prism 39:
has an angle of inclination with the smooth portion of the inclined portion 32 is less than 90 degrees, and more preferably less than or equal to 45 degrees; and/or
forms a bevel oriented towards the upper portion of channelling device 25.
   In particular, such an orientation of the bevels guides the slice as it slides along the inclined portion 32. In some embodiments, the surface 41 of the prism 39 is substantially perpendicular to the smooth portion of the inclined portion 32.

In some embodiments (not shown), the irregularities 32 take the form of domes, spherical segments or ellipsoidal segments. Preferably, and as shown in FIG. 4, the irregularities 39 are distributed in a staggered arrangement over the smooth surface of the inclined portion 32. Such a staggered distribution prevents the formation of a stop line for a slice as the slice slides over the inclined portion 32. In this way, the risks of the slice being immobilised on the smooth portion 32 are reduced.

In some embodiments, such as that shown in FIGS. 1 to 7, the receptacle 26 of the channelling device 25 comprises a side opening 38.

Preferably, the opening 38 is circular on the bottom of the receptacle 26 and extends to a side slot whose width is preferably equal to the diameter of this circular portion. This width is measured perpendicular to the vertical axis A. More preferably, this diameter and width are between two and four centimetres.

In some embodiments, such as that shown in FIGS. 1 to 7, the receptacle 26 has a tapered cylindrical upper portion. In other words, the receptacle 26 is formed, in part, by a tapered cylinder. FIGS. 1 to 4 and 6 show the receptacle 26 with a concave bottom, for example a tapered sphere, this bottom forming an extension of the cylindrical upper portion.

In the second particular embodiment of the device that is the subject of the invention, partially shown in FIG. 8, this food processing device 50 comprises:
a motor unit 51 comprising a motor connected to a rotating drive shaft 52;
a food processing disc (not shown) comprising at least one cutting element set in rotation by this shaft and having a radial cutting amplitude;
a cover (not shown) comprising a chute (not shown) for inserting the foodstuffs to be cut; and
a device 55 for channelling, during the operation of the device, cut foodstuffs out of the device, which channelling device has two side surfaces 53 for holding cut foodstuffs on the channelling device 55, a sliding surface 54 inclined relative to the vertical and, at least at the outlet leading to the outside of the device, a transversal dimension 57 substantially equal to this radial cutting amplitude. The channelling device 55 is integral with the motor unit 51, or can be removed from this motor unit 51 manually and without tools. A through-opening of the channelling device 55 allows the shaft 52 to pass through the inclined sliding surface 54. In a variant, the through-opening is positioned in the horizontal upper platform of the channelling device 55.

A receptacle 56 for sliced foodstuffs is separate from the device 50 and the channelling device 55, removable from this device, or integral with the device, and the horizontal cross-section of which preferably has a larger dimension substantially equal to the radial cutting amplitude. The receptacle is equipped with an abutment surface 58 for stopping the movement of the cut foodstuffs, on the other side of the receptacle 56 relative to the sliding surface 54. A removable receptacle has the advantage of being able to be interchanged according to the dimensions of the foodstuffs to be cut, to better correspond to its maximum diameter.

The inclined sliding surface 54 is vertically aligned with the chute for inserting the foodstuffs to be cut. The sliding surface 54 inclined relative to the vertical of the channelling device 55 forms an angle of between 20 degrees and 70 degrees to the vertical, and preferably between 30 degrees and 60 degrees.

A slice of foodstuff, cut by the processing disc below this chute, drops onto the inclined sliding surface 54 and slides to the outlet of this sliding surface, where it drops onto the receptacle 56. The successively cut slices are superposed, in the order they were cut, in the receptacle 56.

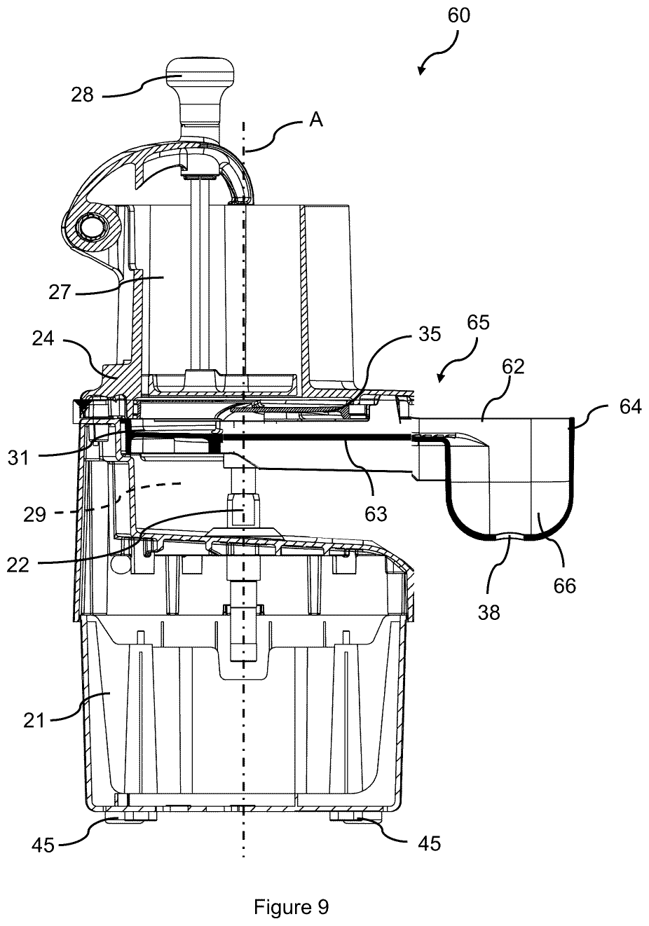

In the third embodiment 60 of a device that is the subject of the present invention, shown in FIG. 9, one finds all the elements of the first embodiment shown in FIG. 3, except that the channelling device 65 comprises a sliding surface 63 that is horizontal, i.e. in a plane perpendicular to the axis A.

Therefore, the device 60 for processing foodstuffs comprises:
a motor unit 21 comprising a motor connected to a rotating drive shaft 22;
a food processing disc 35 comprising at least one cutting element set in rotation by this shaft and having a radial cutting amplitude 47;
a cover 24 comprising a chute 27 for inserting the foodstuffs to be cut; and
a device 65 for channelling cut foodstuffs out of the device 60.

This channelling device 65 has at least one side surface 62 for holding cut foodstuffs on the channelling device 65, one portion comprising a sliding surface 63. The channelling device has a transversal dimension of the outlet for cut foodstuffs from the sliding surface that is substantially equal to the radial cutting amplitude 47. The channelling device 65 successively comprises, at the outlet leading to the outside of the device 60, a receptacle 66 for the sliced foodstuffs, the horizontal cross-section of which has a larger dimension that is substantially equal to the radial cutting amplitude 47, and an abutment surface 64 for stopping the movement of the cut foodstuffs, on the other side of the receptacle 66 relative to the sliding surface 63. In this way, the slices of cut foodstuffs are stopped by this abutment and end course surface 64 and then drop vertically, under the effect of gravity, into the receptacle 66. The other preferential characteristics of the first embodiment of the device 20 also apply to the device 60. In particular, the sliding surface 63 preferably bears irregularities 39 oriented parallel to the plane comprising the axis A and the plane of symmetry of the receptacle 66 (i.e. the plane of FIG. 9). The support for the channelling device 65 in the device 60 is not shown in FIG. 9. It can, for example, take the form of a rib resting on the inclined ramp 30.

1. A device (20, 50, 60) for processing foodstuffs, which device comprises:
a motor unit (21, 51) comprising a motor connected to a rotating drive shaft (22, 52);
a food processing disc (35) comprising at least one cutting element set in rotation by this shaft and having a radial cutting amplitude (47);
a chute (27) for inserting the foodstuffs to be cut;
which device also comprises a device (25, 55, 65) for channelling the cut foodstuffs out of the device, having at least one side surface (42, 43, 53, 62) for holding cut foodstuffs on the channelling device, and a sliding surface (33, 36, 37, 49, 63);
wherein the channelling device successively comprises, at the outlet of the sliding surface leading to the outside of the device, a receptacle (26, 56, 66) for the sliced foodstuffs, the horizontal cross-section of which has a larger dimension that is equal to between three quarters and one and a half times the radial cutting amplitude, and an abutment surface (44, 58, 64) for stopping the movement of the cut foodstuffs on the other side of the receptacle relative to the sliding surface, such that the slices of cut foodstuffs are stopped by this abutment and end course surface and then drop vertically under the effect of gravity into the receptacle.

2. The device (20, 50, 60) according to claim 1, wherein the channelling device (25, 55, 65) has a transversal dimension (46, 57) of the outlet for cut foodstuffs from the sliding surface (33, 36, 37, 49, 63) that is equal to between three quarters and one and a half times the radial cutting amplitude (47).

3. The device (20, 50) according to claim 1, wherein the sliding surface (33, 54) of the channelling device (25, 55) comprises a portion (36, 37) inclined relative to the vertical (A).

4. The device (20, 50) according to claim 3, wherein the portion (36, 37, 54) of the sliding surface (33, 54) inclined relative to the vertical (A) forms an angle of between 20 degrees and 70 degrees to the vertical.

5. The device (20) according to claim 3, wherein a portion (49) of the sliding surface (33) at the lowest end of the portion (36, 37) inclined relative to the vertical (A), is horizontal.

6. The device (20) according to claim 3, wherein the motor unit (21) comprises a ramp (30) inclined relative to the vertical (A), enclosed by vertical rims (42, 43), this inclined ramp having, relative to the vertical (A), a slope with an inclination substantially equal to the slope of an inclined portion (36, 37) of the sliding surface (33) of the channelling device (25).

7. The device (20, 60) according to claim 1, wherein at least one portion (49, 63) of the sliding surface (33, 63) is horizontal.

8. The device (20, 60) according to claim 1, wherein the sliding surface (33, 36, 37, 49, 63) bears irregularities (39) configured to separate the cut foodstuff from the rest of this sliding surface.

9. The device (20, 60) according to claim 8, wherein the irregularities (39) take the form of protrusions (39) in parallel line segments.

10. The device (20, 60) according to claim 1, wherein the channelling device (25) has a transversal dimension between three-quarters and one and a half times the radial cutting amplitude (47), from an upper platform (31) positioned below the chute (27) for the reception of foodstuffs and substantially perpendicular to the axis of the rotating shaft (22), to the outlet for cut foodstuffs leading to the outside of the device.

11. The device (20, 60) according to claim 10, wherein the upper platform only partially surrounds the rotating drive shaft (22).

12. The device (20, 60) according to claim 1, wherein the receptacle (26) comprises a side opening (38) with a width, measured in a horizontal cross-section, of between two and four centimetres.

13. Device (20, 50, 60) according to claim 1, wherein the receptacle (26) has a tapered cylindrical portion extending into a concave bottom.

14. The device (20, 50, 60) according to claim 1, wherein the circle inscribed in a horizontal inner cross-section of the receptacle (26, 56) has a diameter between three quarters and one and a half times the radial cutting amplitude (47).

15. The device (20) according to claim 1, wherein a side surface (42) for holding cut foodstuffs on the channelling device (25) comprises an upper prolongation (34) forming a support for a cover (24) comprising the chute (27).

16. The device (20, 50, 60) according to claim 1, wherein the channelling device (25, 55, 65) comprises two side edges (42, 43, 53).

17. The device (20, 60) according to claim 1, wherein the receptacle (56) can be removed from this device or the channelling device (25, 65).

18. The device (20, 60) according to claim 1, wherein the abutment surface (44) for stopping the movement of the cut foodstuffs extends beyond the plane of the outer edge of the sliding surface (33).

19. The device (20, 60) according to claim 1, wherein the channelling device (25, 65) can be removed from the motor unit (21, 51) manually and without tools.

20. A removable accessory (25, 65) for device (20) according to claim 1, which comprises the device (25, 65) for channelling the cut foodstuffs.
